(19) United States
(12) Patent Application Publication
(10) Pub. No.: US 2005/0028149 A1
(43) Pub. Date: Feb. 3, 2005

(54) Compiler and computer capable of reducing noise in particular frequency band

(75) Inventors: Toshio Takita, Takatsuki-shi (JP); Takashi Yoneda, Mishima-gun (JP)

Correspondence Address: PARKHURST & WENDEL, L.L.P., 1421 PRINCE STREET, SUITE 210, ALEXANDRIA, VA, 22314-2805, US

(73) Assignee: Matsushita Electric Industrial Co., Ltd., Kadoma-shi (JP)

(21) Appl. No.: 10/899,083

(22) Filed: Jul. 27, 2004

(30) Foreign Application Priority Data
Jul. 29, 2003 (JP) 2003-281399

(51) Int. Cl. G06F 9/45

(52) U.S. Cl. 717/150; 455/222

(57) ABSTRACT

There are provided in a compiler (2) a loop detecting part (6) that detects a loop portion from an intermediate code generated from a source program; a loop program formatting part (7) that generates a loop processing program for the loop portion when the loop detecting part (6) detects the loop portion; and, as a loop process changing part that changes the number of instruction steps required for performing the loop processing program generated by the loop program formatting part (7), a nop instruction adding part (11) that changes the loop processing program into a program to which n nop instructions are added.

### FIELD OF THE INVENTION

The present invention relates to a compiler generating a program including a loop process and to a computer executing a program including a loop process.

### BACKGROUND OF THE INVENTION

A compiler translates a source program written in a programming language into an object program to be executed in a given computer. For that purpose, a program analyzing part of the compiler first analyzes the source program, generates an intermediate code according to the result of the analysis, and then an optimizer applies optimization, such as loop fusion, to the intermediate code in order to improve the efficiency of execution of the program, and an code generator transforms the optimized intermediate code into the target program.

Such a known optimization method by means of a compiler is disclosed in Japanese Patent Laid-Open No. 9-114676, for example.

In that known optimization method, a target program is generated such that a loop cycle is minimized with the main aim of minimizing the number of instructions required for loops or execution time. If the instruction execution frequency of a program is 10 MHz and the number of instruction steps in loop processing is 10, then the loop cycle is 10 MHz/10 steps=1 MHz=1,000 KHz, which overlaps the medium radio frequency band.

Therefore, according to the known loop optimization method that minimizes loop cycles, a radio wave that interferes with radio receivers in the vicinity is emitted, thereby disrupting radio reception. There are many devices affected by an interfering wave, namely noise, in a particular frequency band such as a radio frequency band.

### DISCLOSURE OF THE INVENTION

Therefore, an object of the present invention is to provide a compiler and a computer that solve these problems and can reduce generation of noise in a particular frequency band, such as a radio frequency band, to eliminate adverse effects of such noise on devices such as radio receivers.

In order to achieve the object, a compiler of the present invention includes a loop detecting part that detects a loop portion from an intermediate code generated from a source program; a loop program formatting part that, when a loop portion is detected by the loop detecting part, generates a loop processing program for the loop portion; and a loop process changing part that changes the number of instruction steps required for performing the loop processing program generated by the loop program formatting part.

A computer of the present invention includes a memory that stores a series of programs, receives an address signal and an access signal, and outputs a program associated with the address signal in response to the access signal; a CPU that outputs an address signal and an access signal; an address holding circuit that stores a plurality of past address signals outputted from the CPU; a match detecting circuit that compares address signals stored in the address holding circuit with the current address signal being outputted by the CPU and, when finding a match, outputs a wait signal during a plurality of cycles; a CPU control circuit into which a clock signal is inputted and into which a wait signal is inputted from the match detecting circuit, and which outputs the clock signal to the CPU as a control clock signal without modification while the wait signal is negative, and outputs a control clock signal in which the clock signal is kept inactivated for an n cyclic period to the CPU while the wait signal is active.

### BRIEF DESCRIPTION OF THE DRAWINGS

FIG. 1 is a block diagram showing a configuration of a compiler according to a first embodiment of the present invention;

FIG. 2 shows an exemplary process performed by the compiler;

FIG. 3 is a block diagram showing a configuration of a compiler according to a second embodiment of the present invention;

FIG. 4 shows an exemplary process performed by the compiler;

FIG. 5 is a block diagram showing a configuration of a compiler according to a third embodiment of the present invention;

FIG. 6 shows an exemplary process performed by the compiler;

FIG. 7 is a block diagram showing a configuration of a compiler according to a fourth embodiment of the present invention;

FIG. 8 is a block diagram of a computer according to a fifth embodiment of the present invention;

FIG. 9 is a timing chart of signals in the computer;

FIG. 10 is a block diagram of a computer according to a sixth embodiment of the present invention;

FIG. 11 is a timing chart of signals in the computer;

FIG. 12 is a block diagram of a computer according to a seventh embodiment of the present invention; and

FIG. 13 is a timing chart of signals in the computer.

### DESCRIPTION OF THE EMBODIMENTS

Embodiments of the present invention will be described with reference to the accompanying drawings.

### First Embodiment

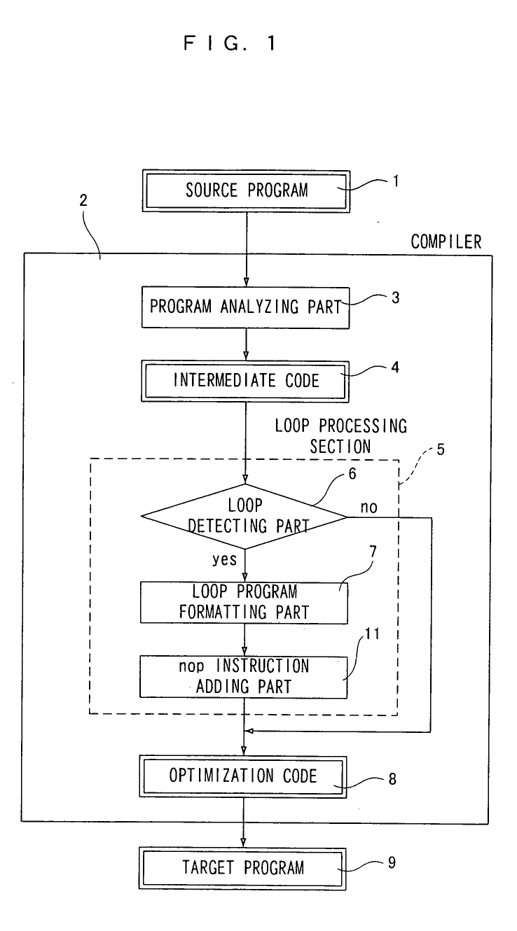

“A compiler capable of reducing noise in a particular frequency band” according to a first embodiment of the present invention will be described below. FIG. 1 is a block diagram showing a compiler according to the first embodiment of the present invention.

As shown in FIG. 1, the compiler 2 includes a program analyzing part 3 which generates an intermediate code 4 when a source program 1 is inputted; and a loop processing section 5 having a loop detecting part 6 which detects a loop portion from an intermediate code 4 generated by the program analyzing part 3, a loop program formatting part 7 which generates a preliminary loop processing program when a loop portion is detected by the loop detecting part 6, and a nop instruction adding part (an example of a loop process modifying part) for changing the number of instruction steps required for performing a loop processing program by adding a wait operation, such as a nop instruction, to the preliminary loop processing program generated in the loop program formatting part 7.

One exemplary operation of the compiler 2 of the first embodiment configured as described above will be described below.

First, a source program 1 is inputted into the compile 2 and the program analyzing part 3 generates an intermediate code 4.

Then, the loop detecting part 6 in the loop processing section 5 detects a loop portion from the intermediate code 4 (program) and the loop program formatting part 7 generates a preliminary loop processing program.

The nop instruction adding part 11 modifies the generated preliminary loop processing program by, for example, adding a number n of nop instructions to the program.

An optimization code 8 generated in this way is used to generate target program 9.

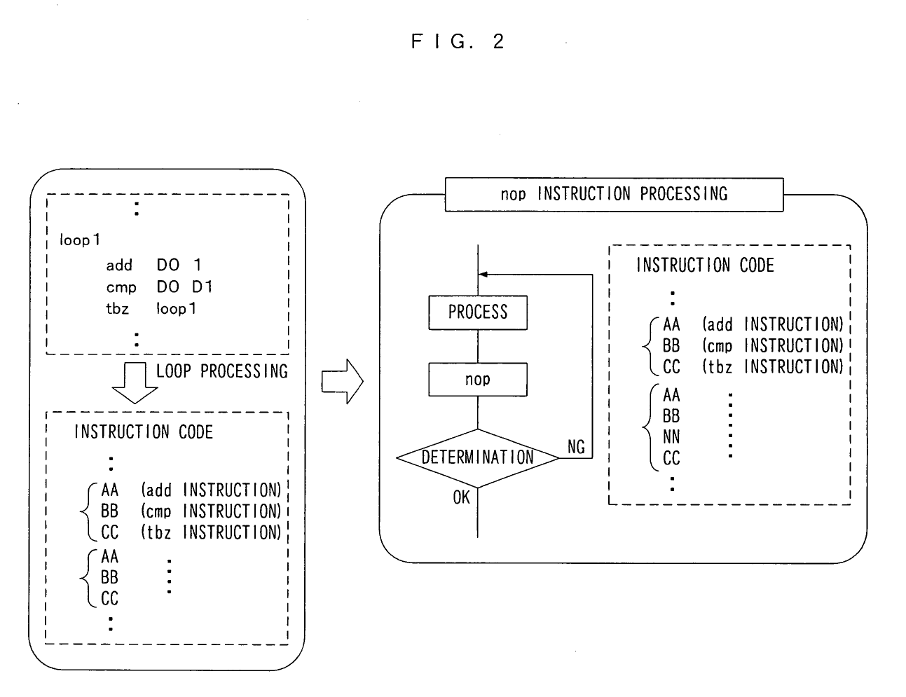

FIG. 2 shows an example of the loop processing by the nop instruction adding part 11. In the process shown in FIG. 2, one nop program is added.

As shown in FIG. 2, in a loop consisting of AA (add instruction), BB (cmp instruction), and CC (tbz instruction), an NN (nop) instruction is added between a process [AA (add instruction) and BB (cmp instruction)] and determination [CC (tbz instruction)].

According to the operation described above, the number of instruction steps of a program including a loop which, if conventional loop processing is used, would generate noise having a frequency in a particular frequency band such as the radio frequency band of a radio broadcast during execution of the program can be significantly changed simply by adding a nop instruction, and the like. Changing per-loop execution time in this way can deviate the frequency of electromagnetic radiation generated based on a loop cyclic period, that is, the frequency of noise, from a particular frequency band such as a radio frequency band, thereby reducing an wave (noise in a particular frequency band) that can cause interference with devices such as radio receivers that can be affected by noise in a particular frequency band.

### Second Embodiment

“A compiler capable of reducing noise in a particular frequency band” according to a second embodiment of the present invention will be described. The same components as those in the first embodiments are labeled with the same reference numbers and description of which will be omitted.

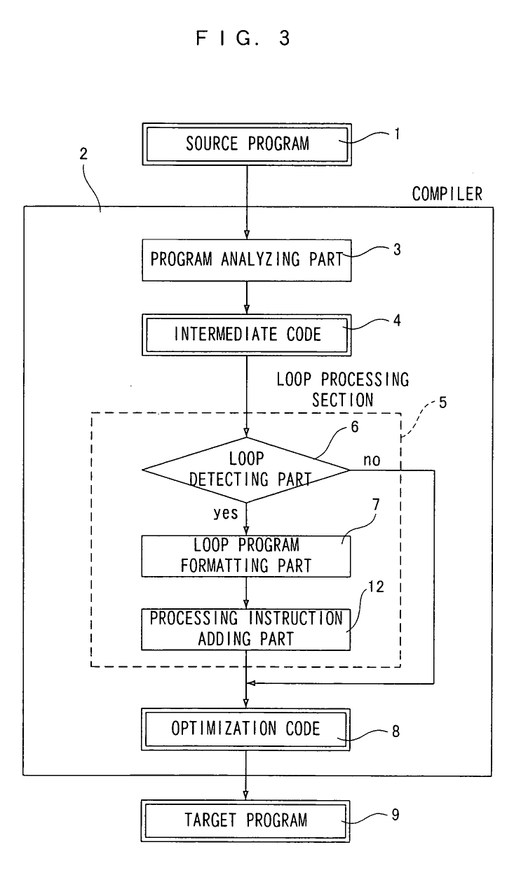

FIG. 3 is a block diagram showing a configuration of a compiler according to the second embodiment of the present invention.

As shown in FIG. 3, a processing instruction adding part (an example of loop process modifying part) 12 is provided in a loop processing section 5 of the compiler 2 in place of the nop instruction adding part 11.

The processing instruction adding part 12 changes the number of instruction steps required for performing a loop processing program by executing an operation within a loop multiple consecutive times in a preliminary loop processing program generated by a loop program formatting part 7.

An example of operation of the compiler 2 of the second embodiment configure as described above will be described below.

First, a source program is inputted into the compiler 2 and a program analyzing part 3 generates an intermediate code 4.

Then, a loop detecting part 6 in the loop processing section 5 detects a loop portion from the intermediate code 4 and the loop program formatting part 7 generates a preliminary loop processing program.

The processing instruction adding part 12 modifies the generated preliminary loop processing program into a program in which a loop instruction is repeated n times, for example.

An optimization code 38 generated in this way is used to generate a target program 39.

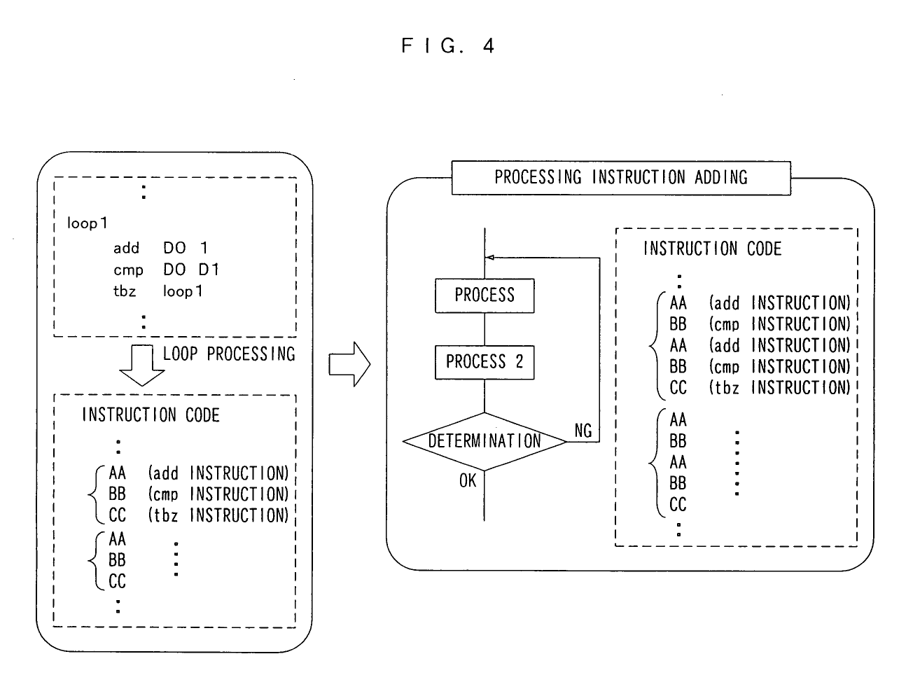

FIG. 4 shows an example of loop processing by the processing instruction adding part 12. The example in FIG. 4 shows a process in which a loop instruction is repeated twice.

A program is changed so that, in a loop process consisting of AA (add instruction), BB (cmp instruction), and CC (tbz instruction) as shown in FIG. 4, a process [AA (add instruction) and BB (cmp instruction)] is repeated as a process 2.

The number of instruction steps of a program including a loop which, if conventional loop processing is used, would generate noise having a frequency in a particular frequency band such as the radio frequency band of a radio broadcast during execution of the program can be significantly changed (per-loop execution time can be increased by a factor of n) by making a modification so that a loop instruction is repeated n times, for example. Consequently, the frequency of electromagnetic radiation generated based on a loop cyclic period, that is, the frequency of noise, can be deviated from a particular frequency band such as a radio frequency band, thereby reducing an wave (noise in a particular frequency band) that can cause interference with devices such as radio receivers that can be affected by noise in a particular frequency band.

### Third Embodiment

“A compiler capable of reducing noise in a particular frequency band” according to a third embodiment of the present invention will be described. The same components as those in the first embodiment are labeled with the same reference numbers and description of which will be omitted.

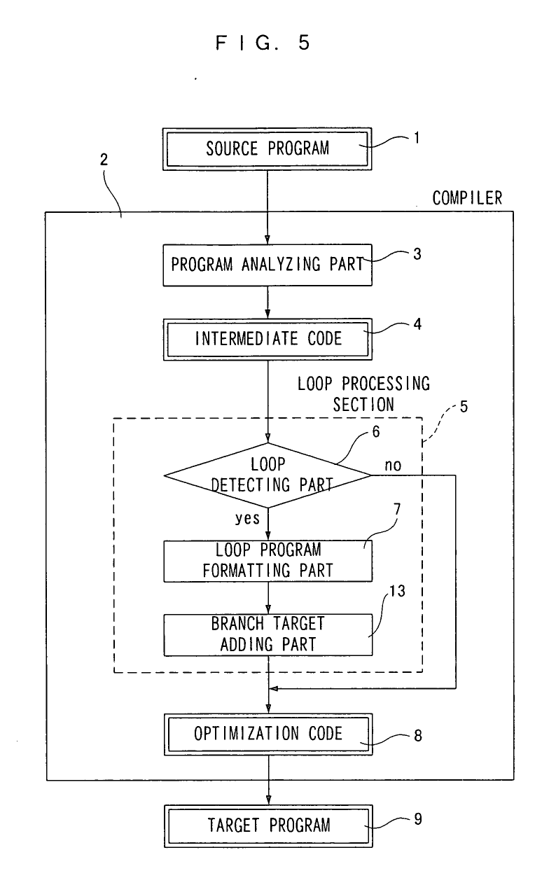

FIG. 5 is a block diagram showing a configuration of a compiler according to the third embodiment of the present invention.

As shown in FIG. 5, a branch target adding part (an example of a loop process modifying part) 13 is provided in a loop processing section 5 of the compiler 2 in place of the nop instruction adding part 11.

The branch target adding part 13 has a flag that changes with iterations. The branch target adding part 13 adds a wait operation such as a nop instruction to an operation executed within a loop in a preliminary loop processing program generated by a loop program formatting part 7 and then causes a branch to a target preceding, following, or inside the added wait operation depending on the state of the flag, thereby changing the number of instruction steps required for the loop program handling.

An example of operation performed by the compiler 2 according to the third embodiment configured as described above will be described below.

First, a source program 1 is inputted in the compiler 2 and a program analyzing part 3 generates an intermediate code 4.

Then, a loop detecting part 6 in the loop processing section 5 detects a loop portion from the intermediate code 4 and a loop program formatting part 7 generates a preliminary loop processing program.

The branch target adding part 13 adds a number n of nap instructions before the generated preliminary loop processing program, for example, and provides (n+1) branch conditions so that branches to the nop instructions occur.

An optimization code 8 generated in this way is used to generate a target program 9.

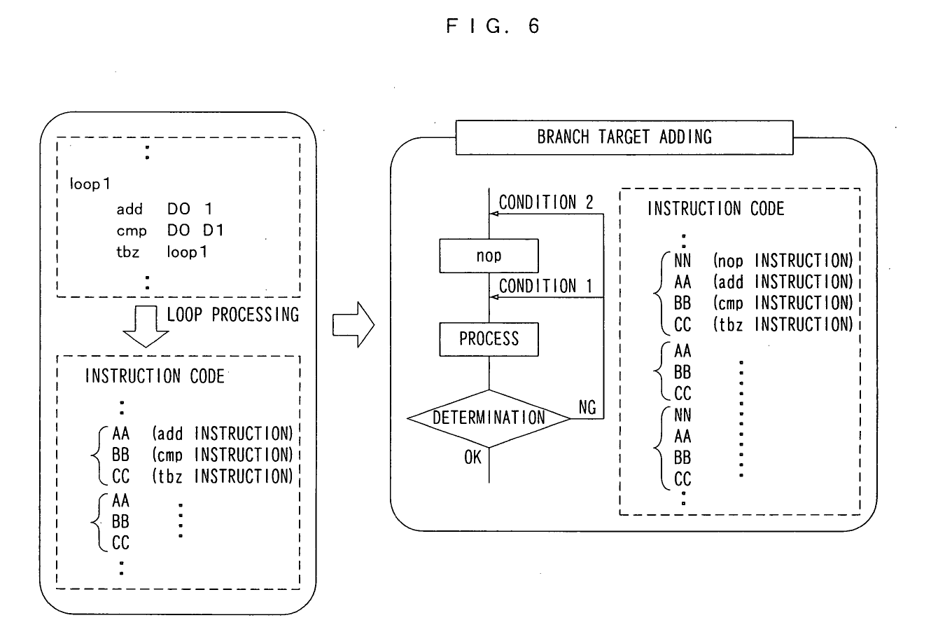

FIG. 6 shows an example of loop processing by the branch target adding part 13. In the process shown in FIG. 6, the one nop instruction is added and two branch conditions are provided.

As shown in FIG. 6, AA (add instruction), BB (cmp instruction), and CC (tbz instruction) are looped. An NN (nop) instruction is added before the loop [AA (add instruction), BB (cmp instruction), and CC (tbz instruction)] and two branch conditions (having a flag that changes with iterations) are provided for CC (tbz instruction) so that a branch can occur to the process [AA (add instruction), BB (cmp instruction), and CC (tbz instruction)] or the process [NN (nop) instruction, AA (add) instruction, BB (cmp instruction), and CC (tbz instruction)].

The number of instruction steps of a program including a loop which, if conventional loop processing is used, would generate noise having a frequency in a particular frequency band such as the radio frequency band of a radio broadcast during execution of the program can be significantly changed (per-loop execution time can be changed for each loop) without increasing the size of the program, by setting n branch targets for a loop instruction so that a branch occurs to a target preceding, following, or inside an added wait operation. Consequently, the frequency of electromagnetic radiation generated based on a loop cyclic period, that is, the frequency of noise, can be deviated from a particular frequency band such as a radio frequency band, thereby reducing an wave (noise in a particular frequency band) that can cause interference with devices such as radio receivers that can be affected by noise in a particular frequency band.

### Fourth Embodiment

A compiler according to a fourth embodiment of the present invention will be described. The same components as those in the first embodiment are labeled with the same reference numbers and description of which will be omitted.

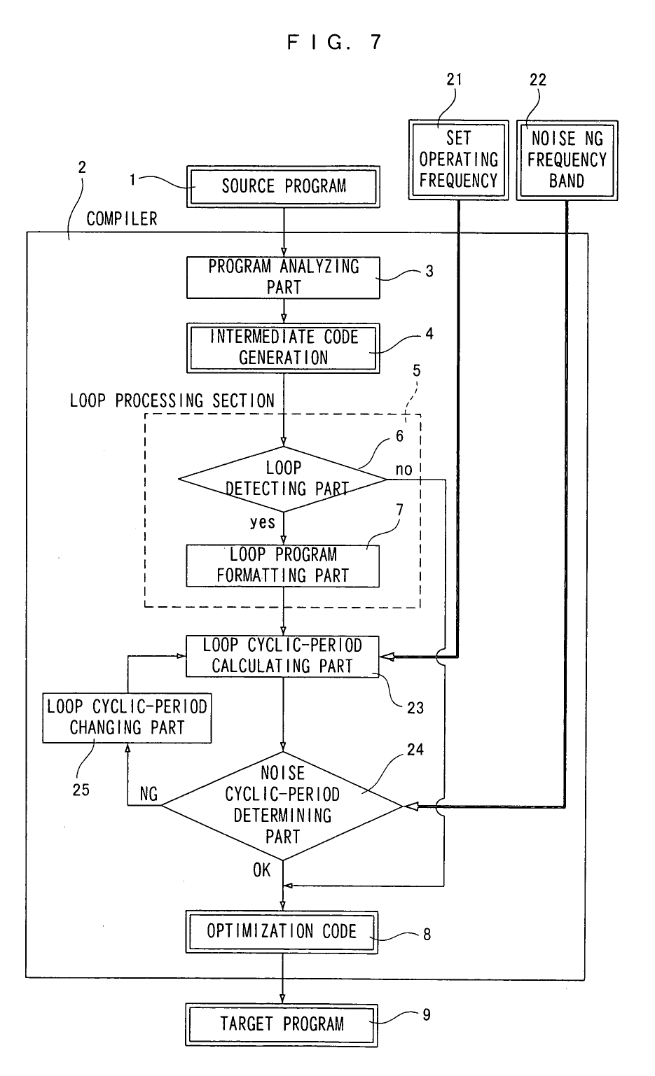

FIG. 7 is a block diagram showing a configuration of a compiler according to the fourth embodiment of the present invention.

As shown in FIG. 7, the execution frequency 21 of a program (set operating frequency) and a radio frequency band(noise NG frequency band, which is an exemplary particular frequency band) 22 are inputted into the compiler 2. Provided in the compiler 2 are a loop cyclic period calculating part 23, a noise cyclic period determining part 24, and a loop cyclic period changing part 25.

The loop cyclic-period calculating part 23 calculates the number of instruction steps required for performing a preliminary loop processing program generated by a loop program formatting part 7 and calculates the number of cyclic periods required for performing the loop processing program from the inputted execution frequency (set operating frequency) 21 and the calculated number of instruction steps.

The noise cyclic period determining part 24 determines whether or not the period calculated by the loop cyclic-period calculating part 23 is in the inputted radio frequency band (noise NG frequency band) 22.

If the noise cyclic-period determining unit 24 determines that it is in the radio frequency band 22, the loop cycle changing part 25 makes a modification such as adding one nop instruction to the loop processing program to change the number of instruction steps required for performing the loop processing program. Thus, the cyclic period required for performing the loop processing program that is calculated by the loop cyclic-period calculating part 23 is changed so as to deviate from the radio frequency band 22.

An exemplary operation of the compile 2 of the fourth embodiment configured as described above will be described below.

First, a source program 1, the execution frequency (set operating frequency) 21 of the program, and a radio frequency band (noise NG frequency band) 22 are inputted into the compiler 2 and a program analyzing part 3 generates an intermediate code 4 from the source program 1.

Then, a loop detecting part 6 of a loop processing section 5 detects a loop portion from the intermediate code 4 and a loop program formatting part 7 generates a preliminary loop processing program.

The loop cyclic-period calculating part 23 uses the set operating frequency 21 inputted initially to calculate the loop processing time of the generated preliminary loop processing program and the frequency of noise generated with the loop processing.

The noise cyclic-period determining part 23 determines whether the frequency of noise calculated is within the radio frequency band 22 inputted initially. If it is within the radio frequency band 22, that is, inappropriate, the loop cyclic-period changing part 25 adds one nop instruction (that is to change the number of instruction steps required for processing the loop processing program in order to change the loop cyclic period). These processes are repeated until the frequency of noise deviates from the radio frequency band 22.

An optimization code 8 generated in this way is used to generate a target program 9.

According to the operation described above, the number of instruction steps of a program including a loop which, if conventional loop processing is used, would generate noise having a frequency in the radio frequency band 22 of a radio broadcast (a particular frequency band) during execution of the program is changed by adding a nop instruction, for example to change per-loop execution time. Consequently, the frequency of electromagnetic radiation, that is, the frequency of noise, generated based on the loop cyclic period can be deviated, by changing per-loop execution time, from the radio frequency band (particular frequency band), thereby reducing an wave (noise in the particular frequency band) that can cause interference with devices such as radio receivers.

While the loop cyclic-period changing part 25 adds one nop instruction in the fourth embodiment, the operation of the nop instruction adding part 11 of the first embodiment, the processing instruction adding part 12 of the second embodiment, or the branch target adding part 13 of the third embodiment described earlier can also be used to achieve the same effect.

### Fifth Embodiment

A computer according to a fifth embodiment of the present invention will be described.

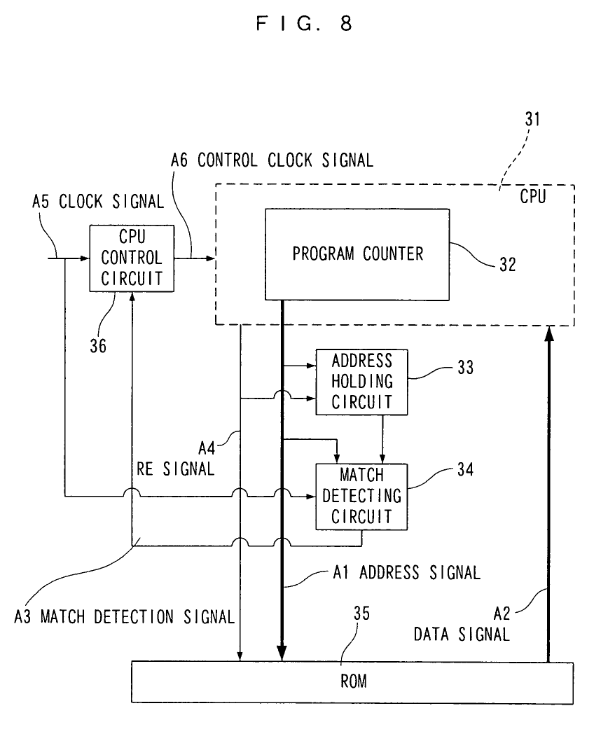

FIG. 8 is a block diagram showing a configuration of “a computer capable of reducing noise in a particular frequency band” according to the fifth embodiment.

In FIG. 8, reference number 31 denotes a CPU and 32 denotes a program counter within the CPU 31. The CPU 31 and the program counter 32 within it operate in synchronization with a clock signal A5 included in a CPU control signal A6, which will be described later, and output an address signal A1 and an RE signal (access signal) A4.

Also provided are an address holding circuit 33, a match detecting circuit 34, a ROM (memory) 35, and a CPU control circuit 36.

The address holding circuit 33 stores address signals A1 for the past m (plurality of) cyclic periods that have been outputted from the program counter 32 in the CPU 31.

The match detecting circuit 34 compares a plurality of address signals stored in the address holding circuit 33 with the current address signal A1 outputted from the program counter 32 of the CPU 31 and, if it finds a match, outputs a match detection signal (wait signal) A3 during the period of n cycles.

The ROM 35 stores a series of programs, receives address signals A1 and RE signals (access signals) A4, and outputs programs associate with the address signals A1 as data signals A2 in response to the access signals A4.

The CPU control circuit 36 receives a clock signal A5 and also receives a match signal (wait signal) A3 from the match detection circuit 34. While the match detection signal A3 is negative, the CPU control circuit 36 continues to output a clock signal A5 to the CPU 31 as a control clock signal A6. While the match detection signal A3 is active, the CPU control circuit 36 outputs a control clock signal A6 in which the clock signal A5 is deactivated for n cyclic periods to the CPU 31 in order to bring the CPU 31 to a halt (place and keep the CPU 31 in a sleep mode).

An exemplary operation of the computer configured as described above will be described below.

Address signals A1 are outputted from the program counter 32 in the CPU 31 to the ROM 35 in sequence.

During this, the address holding circuit 33 temporarily holds address signals A1 for m cyclic periods and the mach detection circuit 34 compares the address signals for m cyclic periods with the next address signal A1 provided from the program counter 32. When finding a match, the match detection circuit 34 determines that a loop is being executed and outputs a match detection signal A3 to the CPU control circuit 36 during n cyclic periods of the clock signal A5.

While the match detection signal A3 is negative, the CPU control circuit 36 outputs the clock signal A5 as is to the CPU 31 as the control clock signal A6. On the other hand, while the match detection signal A3 is active, the CPU control circuit 36 outputs control clock signals A6 in which the clock signal A5 is deactivated during n cyclic periods to the CPU 31 in order to bring the CPU 31 to a halt. When the control clock signal A6 indicates the halt state, the CPU 31 enters the sleep mode.

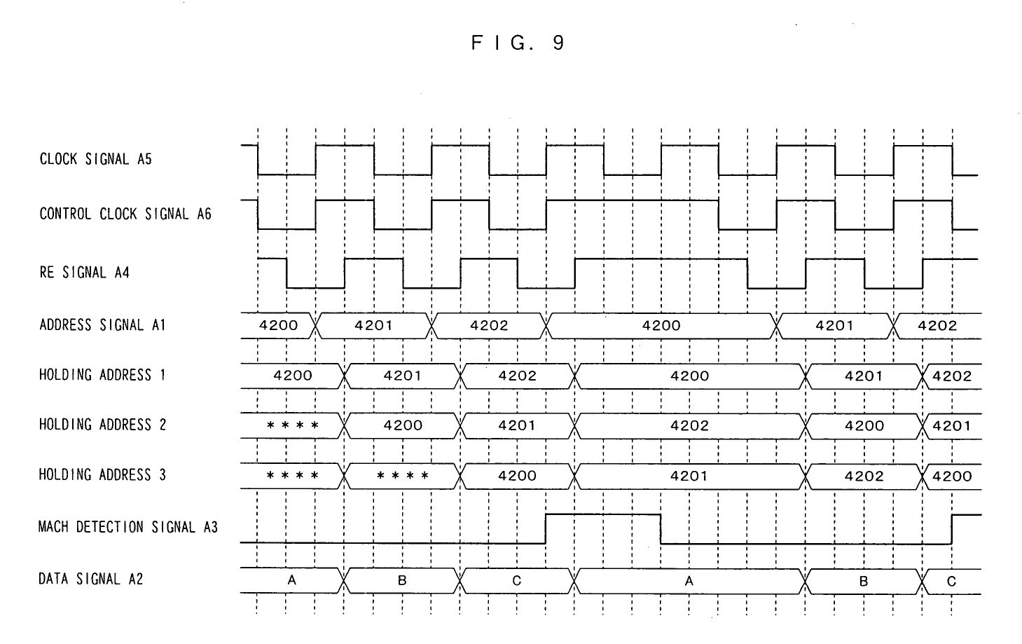

FIG. 9 shows a timing chart of an example of the above-described process.

As shown in FIG. 9, an address signal A1 is stored in the address holding circuit 33 during three cyclic periods at holding address 1, holding address 2, and holding address 3. When the stored address “4200” appears again, it is determined that a loop is being performed and a mach detection signal A3 is outputted (activated) during one cyclic period of the clock signal A5. When the mach detection signal A3 becomes active, the control clock signal A6 becomes the halt state, the CPU 31 is brought to a halt (enters the sleep mode), and the RE signal A4 becomes negative.

According to the above-described processing, when a loop program is detected, the CPU 31 is kept halt during n cyclic periods and therefore the loop cyclic period is changed. Consequently, the cyclic period required for performing the loop processing program is changed and thus electromagnetic radiation generated based on the loop cycle, that is, noise in a particular frequency band can be reduced. Furthermore, because the CPU 31 is kept halt during n cycles, electric current consumption is reduced and therefore the current supply for noise is also reduced, thereby resulting in lower noise.

### Sixth Embodiment

“A computer capable of reducing noise in a particular frequency band” according to a sixth embodiment of the present invention will be described. The same components as those in the fifth embodiment are labeled with the same reference numbers and description of which will be omitted.

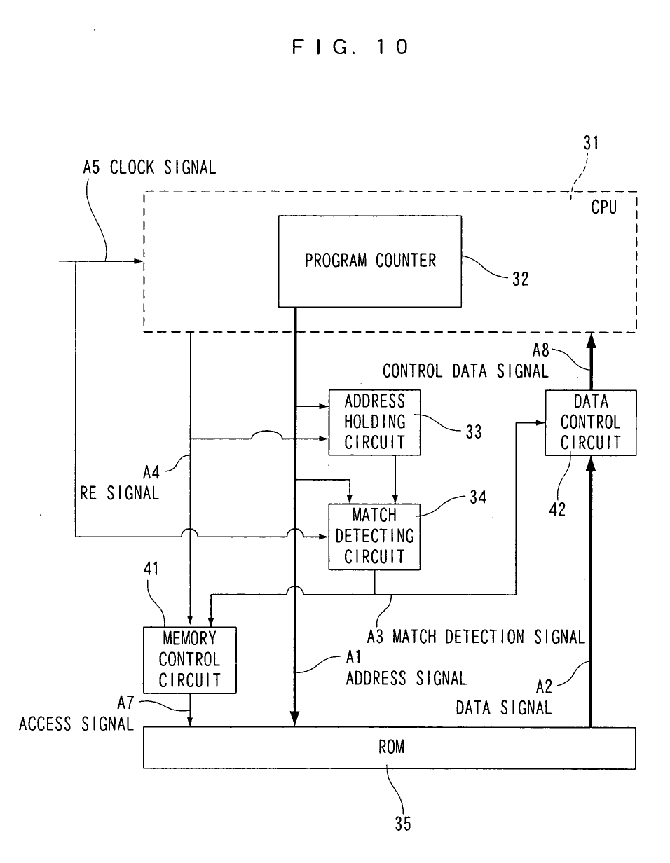

FIG. 10 is a block diagram showing a configuration of a computer according to the sixth embodiment.

The CPU control circuit 36 in the fifth embodiment is replaced with a memory control circuit 41 and a data control circuit 42.

While a match detection signal A3 from the match detection circuit 34 is negative, the memory control circuit 41 outputs an RE signal A4 provided from a CPU 31 as it is to a ROM 35 as an access signal A7. While the match detection signal A3 is active, the memory control circuit 41 makes and keeps the access signal A7 negative (disables the access signal A4 from the CPU 31 to the ROM 35) during n loop cyclic periods in order to stop access to the ROM 35.

The data control circuit 42 stores programs for the past n (plurality of) loop cyclic periods that have been outputted from the ROM (memory) 35. While the match detection signal A3 outputted from the match detection circuit 34 is negative, the data control circuit 42 outputs programs outputted from the ROM 35, as it is, as control data signals A8 to the CPU 31. While the foregoing match detection signal A3 is active, the data control circuit 42 sequentially outputs held data for n loop cyclic periods to the CPU 31 as control data signals A8.

Programs are provided from the data control circuit 42 to the CPU 31.

In addition, a clock signal A5 is provided to the CPU 31 and the match detection circuit 34.

An exemplary operation of the computer of the sixth embodiment configured as described above will be described below.

Address signals A1 are sequentially outputted from a program counter 32 provided within the CPU 31 to the ROM 35.

During this, an address holding circuit 33 temporarily holds address signals A1 for m cyclic periods and the match detection circuit 34 compares the address signals for m cyclic periods with the next address signal A1 outputted from the program counter 32. When finding a match, the math detection circuit 34 determines that a loop is being executed and outputs a match detection signal A4 for n loop cyclic periods to the memory control circuit 41 and the data control circuit 42.

While the match detection signal A3 is negative, memory control circuit 41 outputs an RE signal A4 provided from the CPU 31 to the ROM 35, as it is, as an access signal A7. While the match detection signal A3 is active, the memory control circuit 41 makes and keeps the access signal A7 negative during n loop cyclic periods in order to stop access to the ROM 35. This stops the output of data signals A2 from the ROM 35.

The data control circuit 42, at the same time, sequentially outputs, held data for n cyclic periods of the loop to the CPU 31 as control data signals A8.

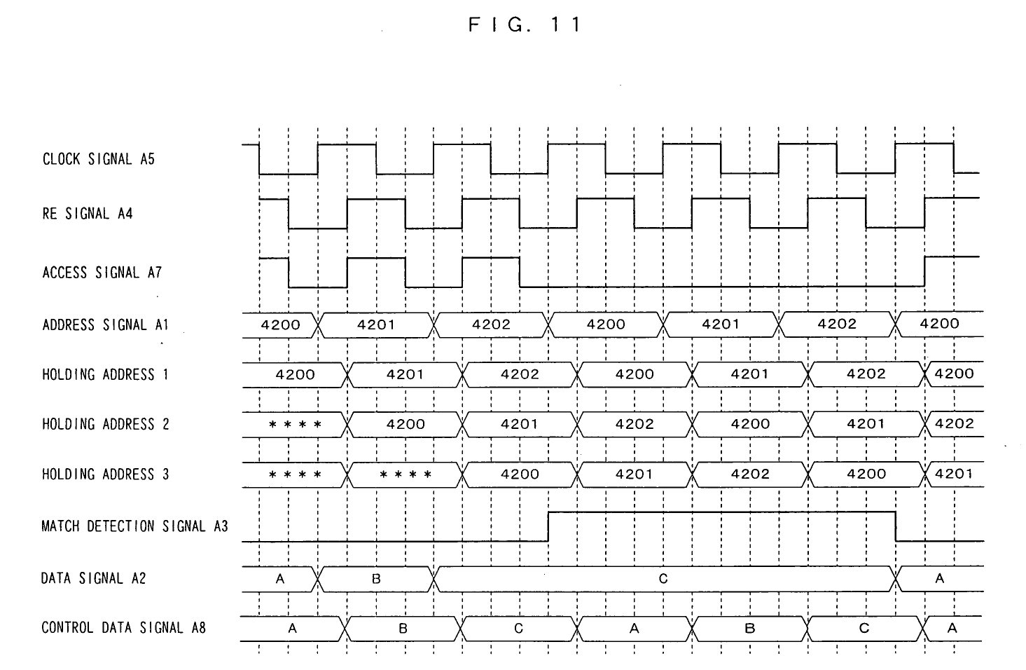

FIG. 11 shows a timing chart of the exemplary operation described above.

As shown in FIG. 11, the address holding circuit 33 holds an address signal A1 for three cyclic periods at holding address 1, holding address 2, and holding address 3. When stored address “4200” reappears, the address holding circuit 33 determines that a loop is being executed, and outputs a match detection signal A3 (keeps it active) during three cyclic periods of the clock signal A5. When the match detection signal A4 becomes active, the access signal A7 becomes and is kept negative during three cyclic periods of access signal A7 and, as a result, the output of data signals A2 from the ROM 35 is stopped. During this, the data control circuit 42 sequentially outputs the held data for three loop cyclic periods to the CPU 31 as control data signals A8.

According to the operation described above, when a loop program is detected, access to the ROM 35 is made stopped during n cyclic periods. As a result, electric current consumption is reduced and therefore the current supply for noise can be reduced, resulting in lower noise. Thus, generation of noise in a particular frequency band can be reduced.

### Seventh Embodiment

“A computer capable of reducing noise in a particular frequency band” according to a seventh embodiment of the present invention will be described.

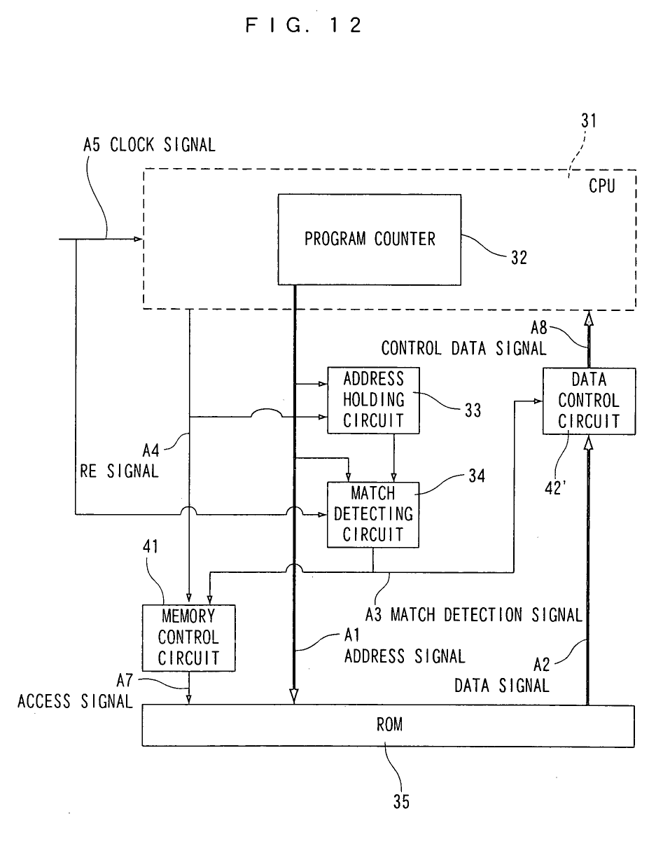

FIG. 12 is a block diagram showing a configuration of a computer according to the seventh embodiment.

As shown in FIG. 12, in the seventh embodiment, a data control circuit 42′ is provided in place of the data control circuit 42 of the sixth embodiment.

The data control circuit 42′ stores programs for the past n (plurality of) loop cyclic periods that have been outputted from the ROM (memory) 35. While the match detection signal A3 from the match detection circuit 34 is negative, the data control circuit 42′ outputs the programs provided from the ROM 35, as it is, as control data signals A8 to the CPU 31. While the match detection signal A3 is active, the data control circuit 42′ adds a wait operation instruction code such as a nop instruction to a program to be provided to the CPU 31 and sequentially outputs held data (programs) for n loops to the CPU 31 as control data signals A8.

An exemplary operation of the computer according to the seventh embodiment configured as described above will be described below.

Address signals A1 are sequentially outputted from a program counter 32 provided in the CPU 31 to the ROM 35.

During this, an address holding circuit 33 temporarily holds address signals A1 for m cyclic periods and a match detection circuit 34 compares the address signals for m cyclic periods with the next address signal A1 outputted from the program counter 32. When finding a match, the match detection circuit 34 determines that a loop is being executed, and outputs a match detection signal A4 to a memory control circuit 41 and the data control circuit 42′ during n loop cyclic periods.

While the match detection signal A3 is negative, the memory control circuit 41 outputs an RE signal A4 provided from the CPU 31, as it is, to the ROM 35 as an access signal A7. On the other hand, while the match detection signal A3 is active, the memory control circuit 41 makes and keeps the access signal A7 negative during n loop cyclic periods in order to stop access to the ROM 35. This halts output of data signals A2 from the ROM 35.

Furthermore, the data control circuit 42′ outputs a nop instruction as a control data signal A8 to the CPU 31 and then sequentially outputs held data for n loop cyclic periods to the CPU 31.

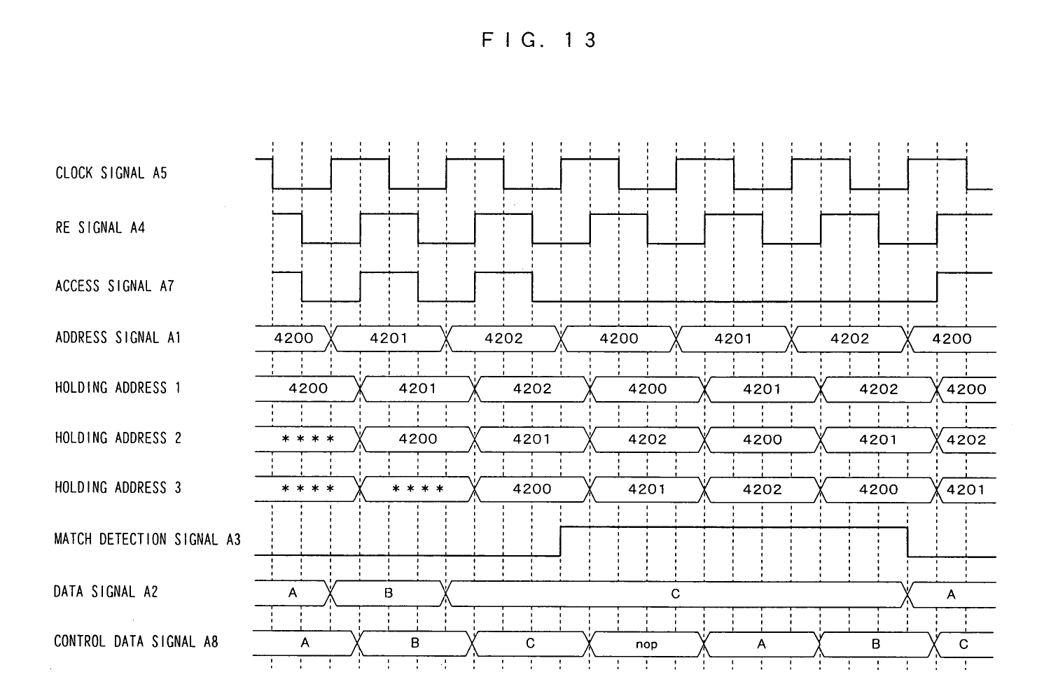

FIG. 13 shows a timing chart of the exemplary process described above.

As shown in FIG. 13, the address holding circuit 33 stores an address signal A1 for three cyclic periods at holding address 1, holding address 2, holding address 3. When stored address “4200” reappears, the address holding circuit 33 determines that a loop is being executed, and outputs a match detection signal A3 (keeps it active) during three cyclic periods of clock signal A5. When the match detection signal A3 becomes active, the access signal A7 becomes and remains negative during three cyclic periods of access signal A7 and thus output of data signals A2 from the ROM 35 is halted. During this, the data control circuit 42′ first outputs a nop instruction to the CPU 31 as a control data signal A8 and then sequentially outputs the held data for three loop cyclic periods to the CPU 31 as control data signals A8.

According to the operation described above, when a loop program is detected, access to the ROM 35 is made stopped during n cyclic periods of the loop program and the loop processing cyclic periods are also changed. Consequently, electric current consumption and therefore the current supply for noise can be reduced, resulting in lower noise. Thus, generation of noise in a particular frequency band can be reduced.

Because the present invention can reduce generation of noise in a particular frequency band, the present invention makes a computer that can reduce noise in a particular frequency band available as a controller in an environment in which noise in such a particular frequency band is not allowed.

1. A compiler capable of reducing noise in a particular frequency band, comprising:
a loop detecting part that detects a loop portion from an intermediate code generated from a source program;
a loop program formatting part that, when a loop portion is detected by said loop detecting part, generates a loop processing program for the loop portion; and
a loop process changing part that changes the number of instruction steps required for performing the loop processing program generated by said loop program formatting part.

2. The compiler capable of reducing noise in a particular frequency band according to claim 1, further comprising, as said loop process changing part, a nop instruction adding part that adds a wait operation to said loop processing program.

3. The compiler capable of reducing noise in a particular frequency band according to claim 1, further comprising, as said loop process changing part, a processing instruction adding part that executes multiple consecutive times an operation to be executed within a loop in said loop processing program.

4. The compiler capable of reducing noise in a particular frequency band according to claim 1, further comprising, as said loop process changing part, a branch target adding part that has a flag changing with iterations, adds a wait operation to said loop processing program, and then causes a branch to a target preceding, following, or inside the added wait operation depending on the state of said flag.

5. A compiler capable of reducing noise in a particular frequency band, comprising:
a loop detecting part that detects a loop portion from an intermediate code generated from a source program;
a loop program formatting part that, when a loop portion is detected by said loop detecting part, generates a loop processing program for the loop portion;
a loop cyclic-period calculating part that calculates the number of instruction steps required for performing the loop processing program generated by said loop program formatting part and calculates a cyclic period required for performing said loop processing program based on an execution frequency of a generated program and the calculated number of instruction steps;
a noise cyclic-period determining part that determines whether or not the calculated cyclic period by said loop cyclic-period calculating part is in a particular frequency band; and
a loop process changing part that, when said noise cyclic-period determining part determines that the calculated cyclic period is in a particular frequency band, changes the number of instruction steps required for performing the loop processing program generated by said loop program formatting part, thereby to change the cyclic period required for performing the loop processing program to be out of said particular frequency band.

6. The compiler capable of reducing noise in a particular frequency band according to claim 5, further comprising, as said loop process changing part, a nop instruction adding part that adds a wait operation to said loop processing program.

7. The compiler capable of reducing noise in a particular frequency band according to claim 5, further comprising, as said loop process changing part, a processing instruction adding part that performs multiple consecutive times an operation to be executed within a loop in said loop processing program.

8. The compiler capable of reducing noise in a particular frequency band according to claim 5, further comprising, as said loop process changing part, a branch target adding part that has a flag changing with iterations, adds a wait operation to said loop processing program, and then causes a branch to a target preceding, following, or inside the added wait operation depending on the state of said flag.

9. A computer capable of reducing noise in a particular frequency band, comprising:
a memory that stores a series of programs, receives an address signal and an access signal, and outputs a program associated with said address signal in response to said access signal;
a CPU that outputs an address signal and an access signal;
an address holding circuit that stores a plurality of past address signals outputted from said CPU;
a match detecting circuit that compares address signals stored in said address holding circuit with the current address signal being outputted by said CPU and, when finding a match, outputs a wait signal during a plurality of cycles;
a CPU control circuit into which a clock signal is inputted and into which a wait signal is inputted from said match detecting circuit, and which outputs said clock signal to said CPU as a control clock signal without modification while said wait signal is negative, and outputs to said CPU a control clock signal in which said clock signal is kept inactivated for n cyclic periods while said wait signal is active.

10. A computer capable of reducing noise in a particular frequency band, comprising:
a memory that stores a series of programs, receives an address signal and an access signal, and outputs a program associated with said address signal in response to said access signal;
a CPU that operates in synchronization with a clock signal to output an address signal and an access signal;
an address holding circuit that stores a plurality of past address signals outputted from said CPU;
a match detecting circuit that compares address signals stored in said address holding circuit with the current address signal being outputted by said CPU and, when finding a match, outputs a wait signal;
a memory control circuit that outputs to said memory an access signal provided from said CPU as an access signal without modification while the wait signal provided from said CPU is negative, and disables an access signal from said CPU to said memory in order to stop access to said memory while said wait signal is active; and
a data control circuit that stores a plurality of past programs outputted from said memory, wherein said data control circuit outputs programs provided from said memory as control data signals to said CPU without modification while the wait signal provided from said match detecting circuit is negative, and sequentially outputs the plurality of held past programs to said CPU as control data signals while said wait signal is active.

11. The computer capable of reducing noise in a particular frequency band according to claim 7, wherein said data control circuit adds an wait operation instruction code to programs to be provided to said CPU and sequentially outputs the programs to said CPU while the wait signal outputted from said match detecting circuit is active.
